(19) United States
(12) Patent Application Publication
(10) Pub. No.: US 2012/0206113 A1
(43) Pub. Date: Aug. 16, 2012

(54) PARAMETER CONFIGURATION METHOD FOR ELEMENTS OF A POWER FACTOR CORRECTION CONVERTER

(76) Inventor: Frank William Kogel, Redlands, CA (US)

(21) Appl. No.: 13/372,368

(22) Filed: Feb. 13, 2012

Related U.S. Application Data
(60) Provisional application No. 61/442,692, filed on Feb. 14, 2011.

(51) Int. Cl. G05F 1/70

(52) U.S. Cl. 323/207

(57) ABSTRACT

Systems and methods for configuring parameters of elements of a power factor correction (PFC) converter are disclosed herein. The PFC converter may include a PFC circuit configured to modulate input power into DC modulated power, and a transformer configured to transform the DC modulated power into an output power. A storage capacitor configuration procedure, a storage inductor configuration procedure, and a phase angle and voltage verification procedure may be utilized with the PFC converter. A phase comparator and storage capacitor configuration may be used to determine a test voltage and phase angle, where a rated bus phase angle that is lower than the test voltage and test phase angle may determine a parameter of the storage capacitor network to supply the rated bus voltage and subsequent phase angle correction.

### RELATED APPLICATIONS

This application claims the benefit of U.S. Provisional Application Ser. No. 61/442,692, filed Feb. 14, 2011, the contents of which are incorporated herein by reference in its entirety as if set forth in full.

### BACKGROUND

1. Field of the Invention

The embodiments described herein relate generally to the field of power factor correction (PFC), and more particularly, to systems and methods for parameter configuration of a PFC converter.

2. Related Art

In conventional converter design processes, the designer has to predetermine the rated voltage of a PFC circuit and adopt a conventional energy-storage element that is able to withstand a voltage level that is equal to the bus voltage. Then, the designer has to make the modulated power output by the energy-storage element stable and exactly reach the predetermined bus voltage. A problem with conventional solutions is that the modulated power output by the storage capacitor tends to fluctuate to a significant degree.

### SUMMARY

Various embodiments of the present invention are directed to systems and methods for configuring parameters of the elements of a PFC function converter. The converter may include a PFC circuit configured to modulate input power into DC modulated power, and a transformer configured to transform the DC modulated power into an output power. A storage capacitor configuration procedure, a storage inductor configuration procedure, and a phase angle and voltage verification procedure may be utilized within the PFC converter circuit. In addition, a phase comparator and storage capacitor configuration may be used to determine a test voltage and phase angle, where a rated bus phase angle that is lower than the test voltage and test phase angle determines a parameter of the storage capacitor network to supply the rated bus voltage and subsequent phase angle correction.

In a first exemplary aspect, a method of parameter configuration of a power factor correction converter circuit is disclosed. In one embodiment, the method comprises: selecting a test voltage based at least in part upon a phase comparator and storage capacitor configuration; selecting a rated bus voltage that is smaller than the test voltage; determining a parameter of a storage capacitor disposed within the power factor correction conversion circuit, wherein said parameter is based at least in part upon the test voltage; configuring the storage capacitor to supply a modulated power having a voltage reaching the test voltage; determining the number of coils of a primary coil associated with a transformer disposed within the power factor correction conversion circuit; determining an inductance of a storage inductor disposed within the power factor correction conversion circuit that is sufficient to enable said inductor and said primary coil to operate in discontinuous current mode; configuring a secondary coil associated with the transformer and an output unit disposed within the power factor correction conversion circuit according to a rated output standard; and verifying whether the power factor of said power factor correction converter circuit is greater than a predetermined threshold.

In a second exemplary aspect, a power factor correction converter circuit is disclosed. In one embodiment, the power factor correction converter circuit comprises: a power source configured to supply power to one or more remote modules; a power factor correction circuit in electrical communication with the power source and comprising a storage inductor, a storage capacitor, and a switch, wherein the power factor correction circuit is configured to modulate received power into DC modulated power; a storage capacitor configuration module in electrical communication with the power factor correction circuit and configured to determine a test voltage and a rated voltage lower than the test voltage in order to set a parameter of the storage capacitor for supplying the rated voltage; a transformer in electrical communication with the power factor correction circuit and configured to transform the DC modulated power; a storage inductor configuration module in electrical communication with the transformer and configured to determine a number of coils of the primary coil of the transformer and to determine an inductance of the storage inductor in order to enable the storage inductor and the primary coil to operate in discontinuous current mode; an output unit connected to a secondary coil of the transformer and configured to receive induced power from the secondary side of the transformer; and a verification module in electrical communication with the output unit and configured to verify whether the power factor of said power factor correction converter circuit is greater than a predetermined threshold.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding of the invention and shall not be considered limiting of the breadth, scope, or applicability of the embodiments. It should be noted that for clarity and ease of illustration these drawings are not necessarily made to scale.

FIG. 1 is a circuit diagram illustrating an exemplary PFC converter according to one embodiment of the present invention.

FIG. 2 is a flow diagram illustrating an exemplary storage capacitor configuration procedure according to one embodiment of the present invention.

FIG. 3 is a flow diagram illustrating an exemplary storage inductor configuration procedure according to one embodiment of the present invention.

FIG. 4 is a flow diagram illustrating an exemplary verification procedure according to one embodiment of the present invention.

FIG. 5 is a waveform diagram representing power transmission as currents flow through the primary and secondary coils of the transformer and inductor of the PFC converter circuit depicted in FIG. 1.

FIG. 6 is a flow diagram illustrating an exemplary process of parameter configuration according to one embodiment of the present invention.

### DETAILED DESCRIPTION

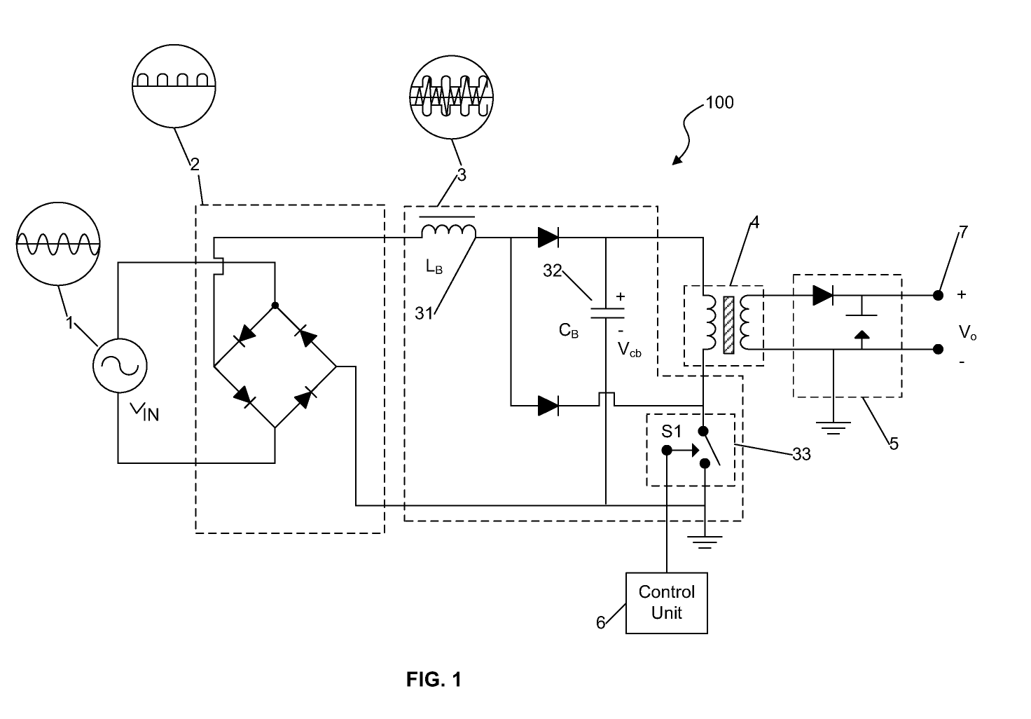

FIG. 1 is a circuit diagram illustrating an exemplary PFC converter 100 according to one embodiment of the present invention. As illustrated by FIG. 1, the PFC converter 100 includes a PFC circuit 3 and a transformer 4. The PFC circuit 3 modulates input power into DC modulated power in a discontinuous current mode, while the transformer 4 transforms the DC modulated power into an output power 7 to a load (not shown).

In some embodiments, the converter 100 may include a rectifier circuit 2 connected to a power source 1 to obtain the input power and an output unit 5 connected to the secondary coil of the transformer 4. The rectifier circuit 2 receives input power and modulates the input power into pulsed DC power, while the PFC circuit 3 receives the pulsed DC power and modulates the pulsed DC power into a modulated power.

When the modulated power is transformed by the transformer 4, the output unit 5 receives induced power from the secondary side of the transformer 4. Optionally, one or more other circuits (for example, a regulation circuit, a filtering circuit, or an impedance-matching circuit) may be used to process the induced power into the output power 7 driving a load.

Returning again to FIG. 1, the PFC circuit 3 may include a storage capacitor 32, a storage inductor 31, a switch 33, and a control unit 6. The control unit 6 may be configured to control activation of the switch 33, while the switch 33 may be configured to determine the direction of the input current (for example, the switch 33 may determine the cycles of charging and discharging of the storage capacitor 32). In some embodiments, the primary coil of the transformer 4 may also require a switch to determine the power transferred to the secondary coil of the transformer 4. As shown in the embodiment depicted by FIG. 1, the same switch 33 of the PFC circuit 3 may also be used to control the power output by the transformer 4. Note, however, that separate switches may be used in the alternative.

Since parameters of the storage capacitor 32 and the storage inductor 31 may greatly influence the power factor, various embodiments of the present invention are directed to methods for configuring the parameters of these particular components. For example, according to one embodiment, a method of parameter configuration may include a storage capacitor configuration procedure, a storage inductor configuration procedure, and a verification procedure. These procedures will now be discussed below, in turn.

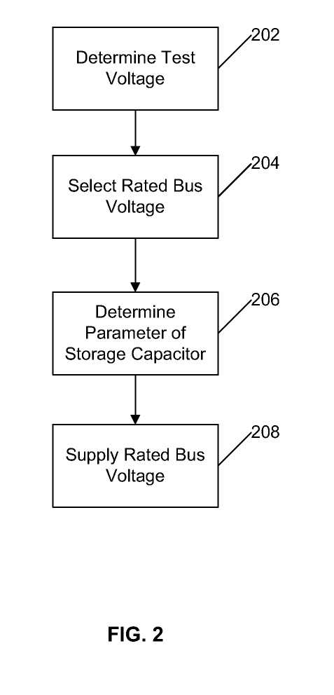

FIG. 2 is a flow diagram illustrating an exemplary storage capacitor configuration procedure according to one embodiment of the present invention. At block 202, the storage capacitor configuration procedure first predetermines a test voltage. At block 204, a rated bus voltage that is less than the test voltage is then selected. Next, at block 206, the parameter of the storage capacitor is determined, where such a parameter is based at least in part upon the test voltage. The storage capacitor may then be used to supply the rated bus voltage at block 208.

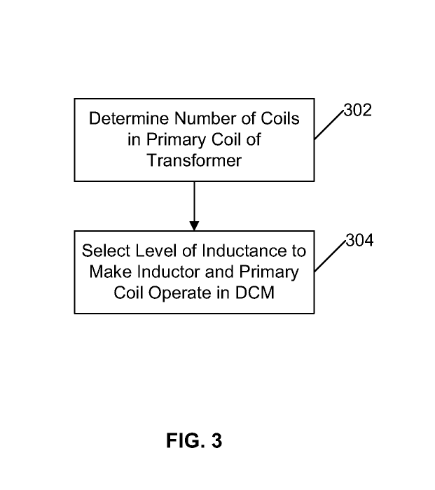

FIG. 3 is a flow diagram illustrating an exemplary storage inductor configuration procedure according to one embodiment of the present invention. At block 302, the number of coils of the primary coil of the transformer is first determined. Then, at block 304, the level of inductance necessary to make the inductor and the primary coil operate in discontinuous current mode (DCM) is then selected.

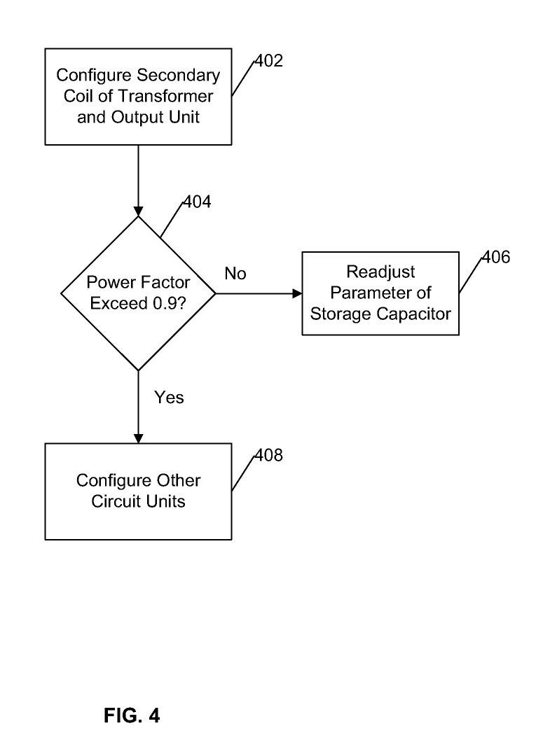

FIG. 4 is a flow diagram illustrating an exemplary verification procedure according to one embodiment of the present invention. At block 402, the secondary coil of the transformer and the output unit are configured. If the power factor does not exceed 0.9, then at block 404, the process returns to the test voltage comparator to adjust the parameter of the storage capacitor at block 406 (e.g., as described above with reference to FIG. 2). However, if the power factor of the converter does exceed 0.9 at block 404, then the circuit output may be routed through one or more other circuit units at block 408 (e.g., a protection circuit or a grounding circuit).

With reference to the exemplary embodiments disclosed above, it should be noted that the bus voltage is a voltage level, and that the average voltage of the modulated power output by the PFC circuit is boosted to the level of the bus voltage. In the exemplary storage capacitor configuration procedure depicted in FIG. 2, and with reference to the PFC converter 100 depicted in FIG. 1, a test voltage higher than the rated voltage may be preset, and the parameter of the storage capacitor 32 may then be determined according to the test voltage. The storage capacitor parameter determined by the test voltage may then be used in the PFC converter 100, and the control unit 6 configured to control the operation of the switch 33 so as to charge and discharge the storage capacitor 32. The storage capacitor 32 may then output the modulated power having a voltage reaching the bus voltage. As the parameter of the storage capacitor is determined by a higher test voltage, the modulated power output by the storage capacitor 32 will fluctuate only slightly (in other words, the storage capacitor 32 will receive a smaller fluctuation of input power).

In the exemplary storage inductor configuration procedure depicted in FIG. 3, and with reference to the PFC converter 100 depicted in FIG. 1, the inductance of the storage inductor 31 may be selected to correspond to the number of coils of the primary coil of the transformer 4, whereby the PFC circuit 3 operates in a discontinuous current mode.

In some embodiments, the inductance of the storage inductor 31 and the number of coils of the primary coil of the transformer 4 may determine the variation rate of the current flowing through the storage inductor 31. Thus, according to the exemplary storage inductor configuration procedure depicted in FIG. 3, the number of coils of the primary coil of the transformer 4 may be initially determined, while the inductance of the storage inductor 31 chosen subsequently in order to achieve a discontinuous current mode.

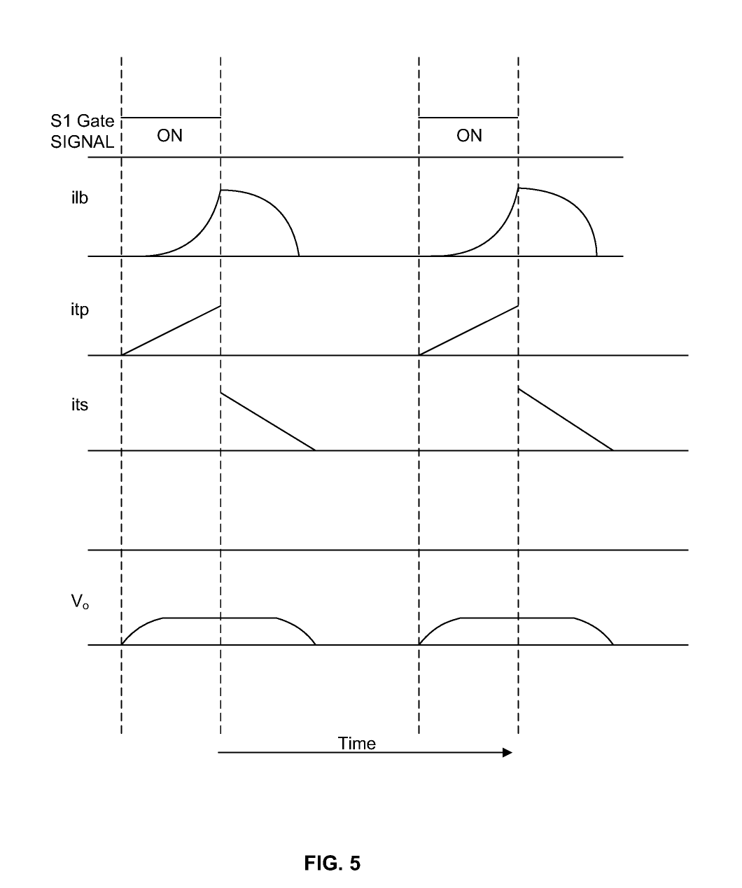

FIG. 5 is a waveform diagram representing power transmission as currents flow through the primary and secondary coils of the transformer and inductor of the PFC converter circuit depicted in FIG. 1. More specifically, FIG. 5 is a diagram illustrating the waveforms of the nodes of the circuit depicted in FIG. 1, wherein i(tp) and i(ts) respectively denote the currents flowing through the primary coil and secondary coil of transformer 4 (that is, the waveforms respectively represent the power transmission process of the primary coil and the secondary coil, wherein i(lb) denotes the current flowing through the storage inductor 31). The current i(lb) initially increases and then decreases to a zero-current stage in each cycle. A new cycle then begins, whereby a discontinuous current mode is achieved. After the number of primary coils of the transformer 4 is determined, a measurement associated with the secondary coil may be determined according to the transformer ratio. In some embodiments, the secondary coil of the transformer 4 may be coupled to the output unit 5 in order to supply stable output power 7.

According to some embodiments, the above mentioned configuration for the PFC circuit 3 may be verified in order to determine whether the power factor of the converter is higher than 0.9. If the power factor is not higher than 0.9, the process may then resume at the exemplary storage capacitor configuration procedure (for example, as that depicted in FIG. 2) in order to determine a new parameter of the storage capacitor 32. On the other hand, if the power factor is higher then 0.9, then the output may be routed to configure additional circuit units.

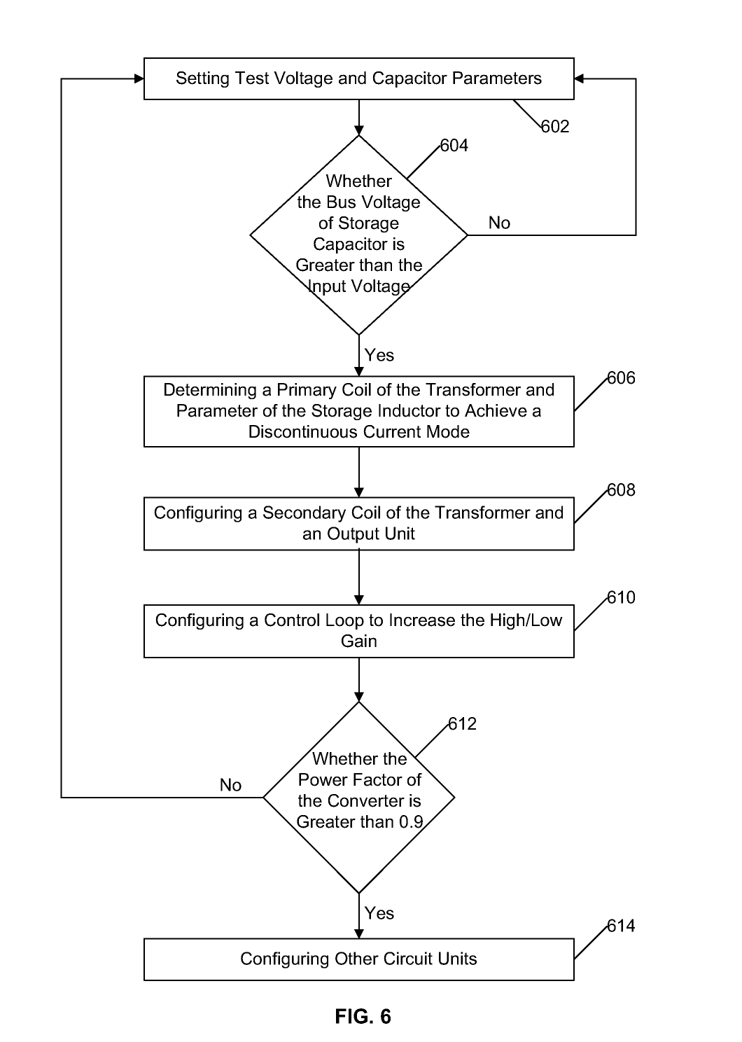

Optionally, a bus voltage verification step may be used to verify whether a bus voltage of the modulated power output by the storage capacitor is higher than a voltage of the input power. Additionally, a control loop design step may be used to inhibit a low-frequency component output by the power factor correction circuit. An exemplary combined method incorporating both of these steps is now described with reference to FIG. 6.

At block 602, a test voltage and a rated bus voltage that is less than the test voltage are first predetermined. A parameter of the storage capacitor may then be selected based upon the test voltage, and the storage capacitor subsequently used to supply a modulated power with a voltage reaching the rated bus voltage.

At block 604, a determination may be made as to whether the bus voltage of the modulated power output by the storage capacitor is greater the voltage of the input power. If the bus voltage of the modulated power output by the storage capacitor is not greater than the input power, then the process resumes at block 602, where a new parameter is selected. Otherwise, the process continues per block 606.

At block 606, the number of primary coils of the transformer is determined, along with a parameter of the storage inductor which would enable the storage inductor and the primary coil of the transformer to operate in discontinuous current mode.

At block 608, the secondary coil of the transformer and an output unit coupled to the secondary coil are configured according to a rated output standard. Next, at block 610, a control loop may be used with a high/low frequency gain means in order to inhibit a low-frequency component output by the power factor correction circuit.

At block 612, a determination is made as to whether the power factor of the converter is greater than 0.9. If this condition is not satisfied, the process repeats per block 602. Otherwise, other circuit units may be configured at block 614, and the process then ends.

While various embodiments of the present invention have been described above, it should be understood that they have been presented by way of example only, and not of limitation. The breadth and scope of the present invention should not be limited by any of the above-described exemplary embodiments. Where this document refers to technologies that would be apparent or known to one of ordinary skill in the art, such technologies encompass those apparent or known to the skilled artisan now or at any time in the future. In addition, the invention is not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the present invention.

Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of parameter configuration of a power factor correction converter circuit, the method comprising:
selecting a test voltage based at least in part upon a phase comparator and storage capacitor configuration;
selecting a rated bus voltage that is smaller than the test voltage;
determining a parameter of a storage capacitor disposed within the power factor correction conversion circuit, wherein said parameter is based at least in part upon the test voltage;
configuring the storage capacitor to supply a modulated power having a voltage reaching the test voltage;
determining the number of coils of a primary coil associated with a transformer disposed within the power factor correction conversion circuit;
determining an inductance of a storage inductor disposed within the power factor correction conversion circuit so as to enable said inductor and said primary coil to operate in discontinuous current mode;
configuring a secondary coil associated with the transformer and an output unit disposed within the power factor correction conversion circuit according to a rated output standard; and
verifying whether the power factor of said power factor correction converter circuit is greater than a predetermined threshold.

2. The method of claim 1, further comprising:
verifying whether the voltage of said modulated power supplied by the storage capacitor is greater than a voltage associated with an input power; and
selecting a new parameter of the storage capacitor if the voltage of said modulated power is not greater than the voltage associated with the input power.

3. The method of claim 1, further comprising:
inhibiting a low-frequency component output by the power factor correction conversion circuit by utilizing a high/low frequency gain module.

4. The method of claim 1, further comprising selecting a new parameter of the storage capacitor if the power factor of said power factor correction converter circuit is not greater than the predetermined threshold.

5. The method of claim 1, wherein the predetermined threshold is 0.9.

6. A power factor correction converter circuit comprising:
a power source configured to supply power to one or more remote modules;
a power factor correction circuit in electrical communication with the power source and comprising a storage inductor, a storage capacitor, and a switch, wherein the power factor correction circuit is configured to modulate received power into DC modulated power;
a storage capacitor configuration module in electrical communication with the power factor correction circuit and configured to determine a test voltage and a rated voltage lower than the test voltage in order to set a parameter of the storage capacitor for supplying the rated voltage;
a transformer in electrical communication with the power factor correction circuit and configured to transform the DC modulated power;
a storage inductor configuration module in electrical communication with the transformer and configured to determine a number of coils of the primary coil of the transformer and to determine an inductance of the storage inductor in order to enable the storage inductor and the primary coil to operate in discontinuous current mode;
an output unit connected to a secondary coil of the transformer and configured to receive induced power from the secondary side of the transformer; and
a verification module in electrical communication with the output unit and configured to verify whether the power factor of said power factor correction converter circuit is greater than a predetermined threshold.

7. The power factor correction converter circuit of claim 6 further comprising a control unit configured to toggle the state of the switch, wherein the switch is configured to control the charging and discharging of the storage capacitor.

8. The power factor correction converter circuit of claim 6 further comprising a rectifier circuit in electrical communication with the power source, wherein the rectifier circuit is configured to obtain power from the power source and modulate the power into pulsed DC power.

9. The power factor correction converter circuit of claim 6 further comprising a regulation circuit configured to process the induced power into output power in order to drive a load.

10. The power factor correction converter circuit of claim 6 further comprising a filtering circuit configured to process the induced power into output power in order to drive a load.

11. The power factor correction converter circuit of claim 6 further comprising an impedance-matching circuit configured to process the induced power into output power in order to drive a load.

12. The power factor correction converter circuit of claim 6, wherein the predetermined threshold is 0.9.

13. The power factor correction converter circuit of claim 6 further comprising a bus voltage verification module configured to verify whether the voltage of said DC modulated power is greater than a voltage associated with power supplied by the power source, and to set a new parameter of the storage capacitor if the voltage of said DC modulated power is not greater than the voltage associated with the power supplied by the power source.

14. The power factor correction converter circuit of claim 6 further comprising a control loop module configured to inhibit a low-frequency component output by the power factor correction circuit by using a high/low frequency gains module.

15. The power factor correction converter circuit of claim 6 further comprising a grounding circuit in electrical communication with output unit.

16. The power factor correction converter circuit of claim 6 further comprising a protection circuit in electrical communication with the output unit.
